(19) United States
(12) Patent Application Publication
(10) Pub. No.: US 2005/0105002 A1
(43) Pub. Date: May 19, 2005

(54) Digest video specification system, digest video providing system, digest video specifying method, digest video providing method, and medium and program therefor

(75) Inventor: Fumio Maehara, Osaka (JP)

Correspondence Address: RATNERPRESTIA, P O BOX 980, VALLEY FORGE, PA, 19482-0980, US

(73) Assignee: Matsushita Electric Industrial Co., Ltd, Osaka (JP)

(21) Appl. No.: 10/501,998

(22) PCT Filed: Jan. 9, 2003
(86) PCT No.: PCT/JP03/00088

(30) Foreign Application Priority Data
Jan. 31, 2002 (JP) 2002-24428

(51) Int. Cl. H04N 7/00

(52) U.S. Cl. 348/552

(57) ABSTRACT

Producing digest video from AV data which includes retrieval means of retrieving multi-angle video from AV data having multi-angle video; digest video specification means of defining the retrieved multi-angle video as digest video; and digest video providing means of providing digest video, and an information terminal which includes receiving means of receiving digest video.

### TECHNICAL FIELD

The present invention relates to, for example, a video-on-demand system, a file server, etc., and more specifically to a digest video specification system, a digest video providing system, a digest video specification apparatus, a digest video providing apparatus, a digest video specifying method, a digest video providing method, a medium and a program for the systems, apparatuses, and methods of providing digest video when it is requested from a terminal.

### BACKGROUND ART

A system for accumulating a large volume of video, audio, computer data, etc. on a hard disk and an optical disk, and transmitting retrieval information at a retrieval request from a terminal has become commercially practical as a video-on-demand system, a file server, etc.

When the above mentioned information is to be provided for payment, a user has a strong demand to check, prior to the actual purchase of the information, whether or not the information is really necessary. To attain this, there has been the development of: a method of preparing menus using a still image, character information, etc. for corresponding information, and presenting them to the terminal; and a system for preparing digest video etc. about corresponding information, playing back the digest video, etc. at a request, performing an accounting process when a purchase request is issued, and transmitting the entire information.

On the other hand, a DVD which is one of optical disks has recently become widespread rapidly because of its high-definition video and high-quality audio playback. As compared with a CD or an LD (laser disk), a DVD can record a larger volume of information. The coding compression technology for recording video and audio on a DVD can be the efficient coding compression technology called MPEG 2. The MPEG 2 enables a high-definition moving picture to be efficiently code-compressed with high quality, and a plurality of programs configured by video and audio data to be time-division multiplexed and recorded on the DVD.

Thus, by recording the video and audio using the coding compression technology of the MPEG 2 on the DVD, the function which cannot be realized on the conventional CD or LD has been realized these days.

The above mentioned function will be described below by referring to an example of recording live concert video of a music artist. In this case, in a live concert hall, various scenes of the concert are taken and recorded by a plurality of cameras. For example, five cameras respectively take the scenes of the “entire band”, only the “vocalist”, only the “guitarist”, only the “bassist”, and only the “drummer”. Thus, the five respective scenes taken at the five camera angles are repeatedly edited until the video work is completed.

Since a DVD can record a large volume of data, and also can time-division multiplex and record a plurality of scenes by the MPEG 2, the plural pieces of video concurrently proceeding in the same time period can be separately recorded by the five cameras (at the angles of the entire band, only the vocalist, only the guitarist, only the bassist, and only the drummer) in such editing process.

Thus, by using the time-division multiplexing system of the MPEG 2 for the DVD, the video (multi-angle video) taken by the respective cameras can be arbitrarily selected and played back by the user of a playback device. This technology is the multi-angle facility of a DVD first introduced to the video media field, and the AV data including the video using the multi-angle facility can be referred to as multi-angle software.

The multi-angle software receives widespread attention in the DVD market as software providing the excellent realism, the persuasion, the stimulus to intellectual interest, and emotional satisfaction by applying the multi-angle facility to the important scenes in the movies and animation.

Practically, in the case of movies, the scene of shoot-out (47 minutes and 5 seconds) of ‘Hannibal’ is simultaneously taken by four cameras, and the user of the playback device can freely select and enjoy any scene of the four scenes concurrently played back.

Furthermore, simultaneously with the complete edition of animation film, a picture conte used in producing the animation film can be concurrently played back by some pieces of software which is referred to as a multi-angle facility. The software having the facility is called multi-angle software.

However, in the case of the system for accumulating a large volume of video, audio, computer data, etc. on a hard disk and an optical disk, and transmitting retrieval information at a retrieval request from a terminal as in the case of the above mentioned video-on-demand system and a file server, the user has a strong demand to check, prior to the actual purchase of the information, whether or not the information is really necessary. Especially when the information is provided for payment, the demand is much stronger.

To satisfy the demand, there has been the development of: a method of preparing menus using a still image, character information, etc. for corresponding information, and presenting them to the terminal; and a system of preparing digest video etc. about corresponding information, playing back the digest video etc. at the request of a user, performing an accounting process when a purchase request is issued from the user, and transmitting the entire information.

Since digest video can be actually obtained by the user playing back a part of the complete edition of a movie or animation, it is useful in determining whether or not the user really requires the video and audio data (hereinafter referred to as AV data) about the movie or animation based on which the digest video can be obtained.

However, to satisfy the demand of the user, it is necessary to first produce the digest video from the AV data of a movie or animation. That is, it is necessary for a provider of the AV data to check in detail which scenes of the AV data are to be edited as digest video, select the portion of the AV data to be used as the digest video, and produce a database of digest video. Therefore, further operations and cost are required to produce digest video in addition to producing the AV data.

That is, there is the problem that additional operations and cost are required to produce digest video from AV data.

Furthermore, in such a media that can perform an interactive operation for DVD or the like, at the time of providing a digest video, it is impossible to interactively present any interesting elements of software by only simply providing the digest video incontinently. For example, it is surely impossible to present any interesting elements of multi-angle function of multi-angle software which is described in the background art. Accordingly, even if the digest video of the multi-angle software is simply provided incontinently, it is surely impossible to make the user interactively understand the interesting elements.

That is, there is such a problem that the interesting elements of software cannot be interactively presented by only simply providing the digest video incontinently.

### DISCLOSURE OF INVENTION

The present invention has been achieved to solve the above mentioned problems, and aims at providing a digest video specification system, a digest video providing system, a digest video specification apparatus, a digest video providing apparatus, a digest video specifying method, a digest video providing method, a medium and a program for the systems, apparatuses, and methods for providing digest video so that necessary operations are not complicated, and can be performed at a low cost in producing digest video from AV data.

Furthermore, the present invention has been developed to solve the above mentioned problems, and aims at providing a digest video specification system, a digest video providing system, a digest video specification apparatus, a digest video providing apparatus, a digest video specifying method, a digest video providing method, a medium and a program for the systems, apparatuses, and methods of providing digest video so that the interesting elements of software can be interactively presented.

The 1^{st} invention of the present invention (corresponding to claim 1) is a digest video specification system, comprising: a first device, comprising: retrieval means of retrieving multi-angle video from AV data having said multi-angle video; and digest video specification means of defining said multi-angle video as digest video; and a second device for receiving said provided digest video.

The 2^{nd} invention of the present invention (corresponding to claim 2) is a digest video providing system, comprising:
a first device, comprising: retrieval means of retrieving multi-angle video from AV data having the multi-angle video; digest video specification means of defining the retrieved multi-angle video as digest video; and providing means of providing the digest video; and
a second device comprising receiving means of receiving said digest video.

The 3^{rd} invention of the present invention (corresponding to claim 3) is a digest video specification apparatus, comprising:
retrieval means of retrieving multi-angle video from AV data having said multi-angle video; and
digest video specification means of defining said multi-angle video as digest video.

The 4^{th} invention of the present invention (corresponding to claim 4) is a digest video providing apparatus, comprising:
a digest video specification apparatus according to the 3^{rd} invention; and
providing means of providing said digest video.

The 5^{th} invention of the present invention (corresponding to claim 5) is the digest video providing apparatus according to the 4^{th} invention, wherein multi-angle video of said digest video is interactively processed.

The 6^{th} invention of the present invention (corresponding to claim 6) is the the digest video providing apparatus according to the 4^{th} invention, wherein said providing means provides AV data of a complete edition using a correspondence table between digest video and the AV data of the complete edition when the AV data of the complete edition is requested by specifying said digest video.

The 7^{th} invention of the present invention (corresponding to claim 7) is the digest video providing apparatus according to the 6^{th} invention, further comprising accounting means of performing an accounting process before transmitting the AV data of said complete edition.

The 8^{th} invention of the present invention (corresponding to claim 8) is the digest video specification apparatus according to the 3^{rd} invention, wherein said AV data is stored on a DVD.

The 9^{th} invention of the present invention (corresponding to claim 9) is the digest video providing apparatus according to any one of the inventions 4 to 7, wherein said AV data is stored on a DVD.

The 10^{th} invention of the present invention (corresponding to claim 10) is the a digest video specifying method of specifying digest video by using multi-angle video from AV data having said multi-angle video.

The 11^{th} invention of the present invention (corresponding to claim 11) is the a digest video specifying method of retrieving multi-angle video from AV data having said multi-angle video, and defining the multi-angle video as digest video.

The 12^{th} invention of the present invention (corresponding to claim 12) is the a digest video providing method using a digest video specifying method according to the 11^{th} invention, wherein a multi-angle video is retrieved and provided.

The 13^{th} invention of the present invention (corresponding to claim 13) is the a program which is used in a digest video specifying method according to the 11^{th} invention, and is used to direct a computer to perform all or a part of:
a step of retrieving multi-angle video from AV data having the multi-angle video; and
a step of defining the multi-angle video as digest video.

The 14^{th} invention of the present invention (corresponding to claim 14) is the a program which is used in a digest video providing method according to the 12^{th} invention, and is used to direct a computer to perform all or a part of:
a step of retrieving multi-angle video from AV data having the multi-angle video;
a step of defining the multi-angle video as digest video; and
a step of retrieving and providing the multi-angle video.

The 15^{th} invention of the present invention (corresponding to claim 15) is a medium storing the program according to the 13^{th} invention, wherein said medium can be processed by a computer.

The 16^{th} invention of the present invention (corresponding to claim 16) is a medium storing the program according to the 14^{th} invention, wherein said medium can be processed by a computer.

### BRIEF DESCRIPTION OF DRAWINGS

FIG. 1 shows a configuration of a video providing system according to a first embodiment of the present invention;

FIG. 2 is a flowchart of an operation of the video providing apparatus according to the first embodiment of the present invention;

FIG. 3 shows an example of an address management table according to the first embodiment of the present invention;

FIG. 4 shows an example of branch target information which is a component of the address management table according to the first embodiment of the present invention;

FIG. 5 shows an example of a menu screen according to the first embodiment of the present invention;

FIG. 6 shows an example of an explanation screen according to the first embodiment of the present invention;

FIG. 7 shows an example of a purchase information screen according to the first embodiment of the present invention; and

FIG. 8 shows communications of information between a video providing apparatus and an information terminal according to the first embodiment of the present invention.

### DESCRIPTION OF SYMBOLS

1 VIDEO PROVIDING APPARATUS
2 REPLICATION MEANS
3 VIDEO DATABASE
4 RETRIEVAL MEANS
5 DIGEST VIDEO SPECIFICATION MEANS
6 DIGEST VIDEO PROVIDING MEANS
7 ACCOUNTING MEANS
8 ADDRESS MANAGEMENT TABLE
9 INFORMATION TERMINAL
10 INSTRUCTION MEANS
11 RECEIVING MEANS
12 DISPLAY MEANS
22 NETWORK UPLINE
23 NETWORK DOWNLINE

### BEST MODE FOR CARRYING OUT THE INVENTION

The embodiment of the present invention will be described below by referring to the attached drawings.

### First Embodiment

Described below will be a first embodiment of the present invention.

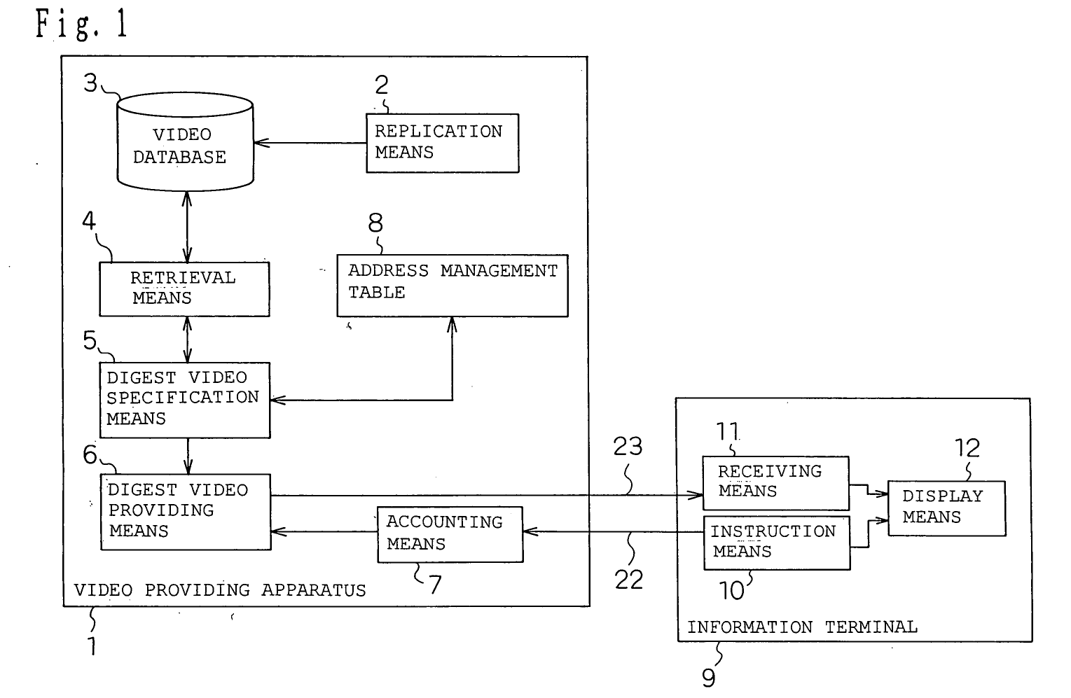

FIG. 1 shows a video providing system according to the first embodiment of the present invention.

The video providing system according to the present embodiment is configured by a video providing apparatus 1 and an information terminal 9.

The video providing apparatus 1 provides a multi-angle software which is the AV data of digest video and a complete edition corresponding to the digest video when a request is received from the information terminal 9.

The information terminal 9 requests the video providing apparatus 1 and receives digest information.

The video providing apparatus 1 comprises replication means 2, a video database 3, retrieval means 4, digest video specification means 5, digest video providing means 6, accounting means 7, and an address management table 8.

The information terminal 9 comprises instruction means 10, receiving means 11, and display means 12.

In FIG. 1, a network upline 22 provides information from the information terminal 9 to the video providing apparatus 1, and a network downline 23 transmits information such as the AV data of digest information and the AV data of a complete edition corresponding to the digest information, etc. from the video providing apparatus 1 to the information terminal 9.

In the video providing apparatus 1 shown in FIG. 1, the replication means 2 replicates multi-angle software recorded on a DVD for sale to the video database 3, and has the functions of, for example, a DVD drive.

The video database 3 is a database of multi-angle software stored on a hard disk medium, and is obtained by sequentially recording the multi-angle software output from the replication means 2 to the hard disk medium.

The retrieval means 4 retrieves a portion having a multi-angle facility in the multi-angle software stored in the video database 3, that is, multi-angle video, stores it in the video database 3 separately from the original multi-angle software, and outputs the retrieved multi-angle video to the digest video specification means 5.

The digest video specification means 5 specifies the multi-angle video output from the retrieval means 4 as digest video, registers in the address management table 8 the address of the digest video of the multi-angle video in the video database 3, and associates the digest video with the multi-angle software including the complete edition corresponding to the digest video.

Upon receipt of a request for digest video from the information terminal 9, the digest video providing means 6 provides the requested digest video, and provides the requested multi-angle software when the information terminal 9 requests the multi-angle software including the complete edition corresponding to the digest video specified by the information terminal 9.

When the information terminal 9 requests the multi-angle software including the complete edition by specifying the digest video, the accounting means 7 performs an accounting process relating to the requested multi-angle software.

The address management table 8 stores the branch target according to the story of the digest video, and the information associating the digest video with the multi-angle software from which the digest video has been retrieved.

On the other hand, in the information terminal 9 shown in FIG. 1, the instruction means 10 indicates a GUI screen displayed on the display means 12 in requesting the video providing apparatus 1 to transmit digest video through the network upline 22 and, issuing a purchase request for the multi-angle software of the complete edition corresponding to the digest video.

The receiving means 11 receives multi-angle software including menu screen information, digest video, and the complete edition from the video providing apparatus 1 through the network downline 23.

The display means 12 displays multi-angle software including a GUI screen, digest video, and the complete edition.

Described below will be the operations of the present embodiment.

The video providing apparatus 1 prepares a database as the video database 3 of multi-angle software including digest information and the complete edition corresponding to the digest video to be provided for the information terminal 9.

According to the present embodiment, the multi-angle software stored as a database in the video database 3 to be provided for the information terminal 9 is the same as the multi-angle software explained above by referring to the conventional technology. That is, the multi-angle software provided from the video providing apparatus 1 is the AV data having the multi-angle facility for a user arbitrarily selecting and playing back the video recorded by a plurality of cameras as concurrently proceeding in the same time period, and is originally recorded on a DVD. Furthermore, the multi-angle software according to the present embodiment includes animation and a picture conte to be concurrently provided. That is, the multi-angle software to be processed in the present embodiment is AV data originally recorded on a DVD, stores at least in a part of it a plurality of scenes concurrently proceeding at the same time period, and has the multi-angle facility of watching the plurality of scenes by freely switching them.

When the multi-angle facility is used in all scenes of the complete edition during the production of multi-angle software, it is impossible to completely record the entire movie or animation on one DVD because of the restriction of the recording capacity of the DVD, and the producing cost of the multi-angle software increases with an increasing number of concurrently proceeding multi-angle scenes.

Therefore, the multi-angle facility used in multi-angle software is normally used in a part of scenes, not in all of the scenes of the multi-angle software. Therefore, the multi-angle facility is limited to the scenes in which the producer of the multi-angle software intends to give the excellent realism, give persuading explanation, satisfy intellectual interest, and give emotional satisfaction to the user of the playback device. That is, the multi-angle facility is limited to important scenes in all scenes forming the multi-angle software.

Thus, the multi-angle facility in the multi-angle software is used in a part of scenes, not all parts of scenes, and is used only in important scenes of all scenes forming the multi-angle software. The video providing apparatus 1 of the present embodiment automatically generates the digest video based on the above mentioned facts.

That is, when a DVD storing multi-angle software is inserted, the replication means 2 replicates the multi-angle software recorded on the DVD in the video database 3. Normally, a copy prohibiting process is performed on a DVD storing software such as a movie, animation, etc. for protection of copyright, but the replication means 2 can generate a replica of software stored on the DVD by agreement of the copyright holder regardless of the presence/absence of the copy prohibiting process.

The replication means 2 replicates the multi-angle software stored on a DVD in the video database 3 each time the DVD is inserted. When a replica of multi-angle software is replicated to the video database 3, the replication means 2 adds a multi-angle software ID which is an ID for specification of multi-angle software to be replicated. A multi-angle software ID will be described later in detail when the address management table 8 is explained.

Then, the retrieval means 4 retrieves the portion having a multi-angle facility, that is, multi-angle video, from the multi-angle software stored in the video database 3, and outputs the retrieved multi-angle video to the digest video specification means 5. The digest video specification means 5 specifies a portion available as digest video in the multi-angle video, and registers the portion in the address management table 8.

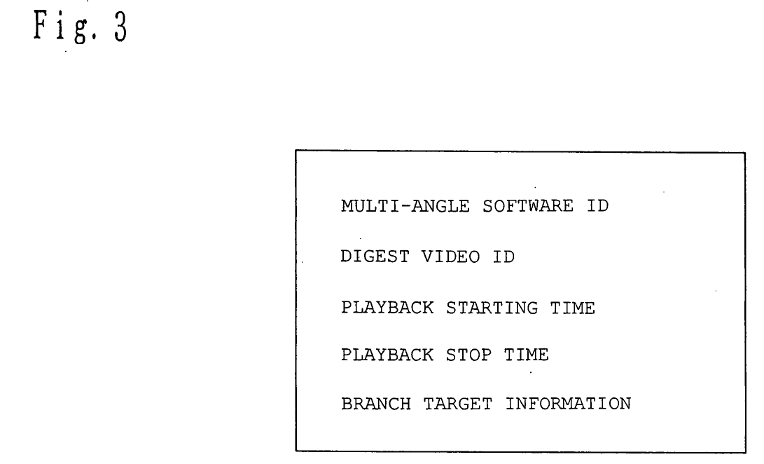

That is, the digest video specification means 5 automatically specifies digest video from multi-angle video by registering the information shown in FIG. 3 in the address management table 8.

That is, FIG. 3 shows an example of the address management table 8. The address management table 8 shown in FIG. 3 contains: a multi-angle software ID for specification of multi-angle software from the video database 3; a digest video ID for specification of digest video from the video database 3; a playback starting time and playback stop time indicating the portion available as digest video in the multi-angle video; and branch target information about the multi-angle video.

A multi-angle software ID can be an ID added for uniquely identifying the multi-angle software when the replication means 2 replicates a DVD storing the multi-angle software as described above. For example, the replication means 2 adds a number of 1023 as a multi-angle software ID to the 1023rd replicated multi-angle software. Thus, a serial number indicating the replication order of the multi-angle software ID can be used.

A digest video ID can be, for example, numbers and character strings including a multi-angle software ID and a chapter number of the multi-angle video for use as digest video. For example, assuming that the multi-angle software ID is 1023 and the chapter number of the multi-angle video for use as digest video is 8, a character string of 1023-8 can be used as a digest video ID. Thus, by using a multi-angle software ID and a digest video ID, multi-angle software can be associated with digest video. Furthermore, the chapter number of multi-angle software for digest video can also be specified.

The playback starting time and the playback stop time respectively indicates the playback time from the start of the multi-angle video. The playback starting time indicates the starting time of the portion available as digest video in the multi-angle video, and the playback stop time indicates the stop time of the portion available as digest video in the multi-angle video.

Thus, the address management table 8 functions as a correspondence table for correspondence between multi-angle software and digest video of the multi-angle software.

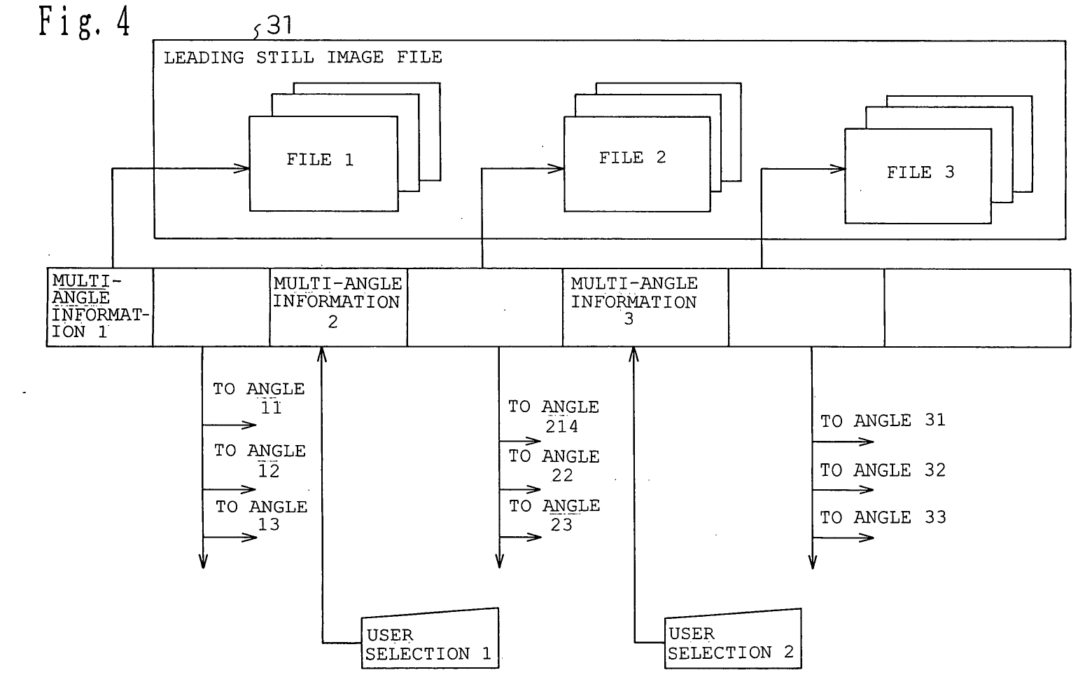

FIG. 4 shows an example of branch target information of the address management table 8. The branch target information indicates the branch target of multi-angle video as shown in FIG. 4. FIG. 4 shows three types of branch target information, that is, multi-angle information 1, multi-angle information 2, and multi-angle information 3. Using the branch target information, the leading still image file and the video of an angle corresponding to the still image file can be specified for each piece of multi-angle information. For example, the branch target information about the multi-angle information 1 comprises address information for reference to the leading still image file of the multi-angle video, and address information for reference to each multi-angle video. The multi-angle information 1 forms multi-angle video by the video of three angles, that is, an angle 11, angle 12, and angle 13. The branch target information refers to information for branch to a video of a corresponding angle when the user specifies the leading still image file. Using the branch target information, plural pieces of multi-angle video concurrently proceeding can be arbitrarily switched and displayed at an instruction of the user.

When multi-angle video is longer than a predetermined time, for example, longer than 3 minutes, the digest video specification means 5 specifies the AV data for 3 minutes, and defines it as digest video. When multi-angle video is shorter than a predetermined time, for example, equal to or shorter than 3 minutes, the digest video specification means 5 specifies the multi-angle video as digest video. The portion of the multi-angle video for use as digest video is recorded in the address management table 8 by setting the playback starting time and the playback stop time as shown in FIG. 3. When the multi-angle video is longer than 3 minutes, the digest video specification means 5 specifies as digest video the multi-angle video for 3 minutes from the start of the multi-angle video. The digest video is not limited to this setting, but the digest video specification means 5 can specify as digest video any portion of the multi-angle video for 3 minutes in the multi-angle video. In any case, the digest video specification means 5 registers the branch target information shown in FIG. 4 in the address management table 8.

Thus, when digest video is selected from multi-angle video, the digest video specification means 5 simultaneously registers in the address management table 8 the branch target information which refers to the branch target in accordance with the story of the digest video in the video database 3 of the digest video, the information for association between the digest video and the original multi-angle software, and the information specifying the portion for use as the digest video in the multi-angle video.

The video providing apparatus 1 repeats the above mentioned operations each time a DVD storing multi-angle software is inserted into the replication means 2, and automatically generates digest information. Thus, the video providing apparatus 1 registers the multi-angle software and the digest video to be provided for the information terminal 9 in the video database 3.

Described below will be the operations performed when the video providing apparatus 1 provides the information terminal 9 with the digest video and the multi-angle software prepared in the above mentioned operations.

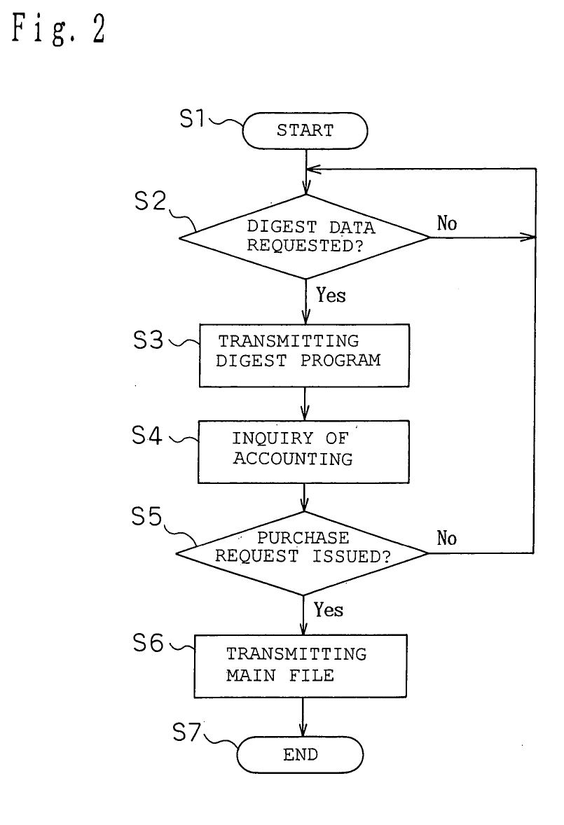

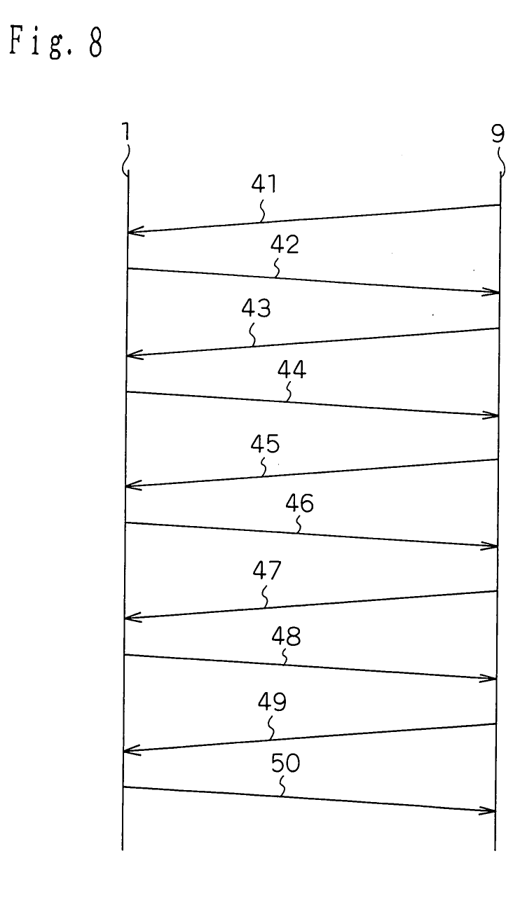

FIG. 2 is a flowchart of operations of the video providing apparatus. FIG. 8 shows communications of data between the video providing apparatus 1 and the information terminal 9.

First, the instruction means 10 of the information terminal 9 requests a menu screen by specifying and selecting a GUI displayed on the display means 12. The request is transmitted to the digest video providing means 6 from the instruction means 10 through the network upline 22 as shown in the a menu screen request 41 shown in FIG. 8. Upon receipt of the menu screen request 41, the digest video providing means 6 transmits the menu screen to the information terminal 9. That is, as shown in a menu screen transmission 42 shown in FIG. 8, the menu screen is transmitted to the receiving means 11 through the network down line 23, and the menu screen received by the receiving means 11 is displayed on the display means 12.

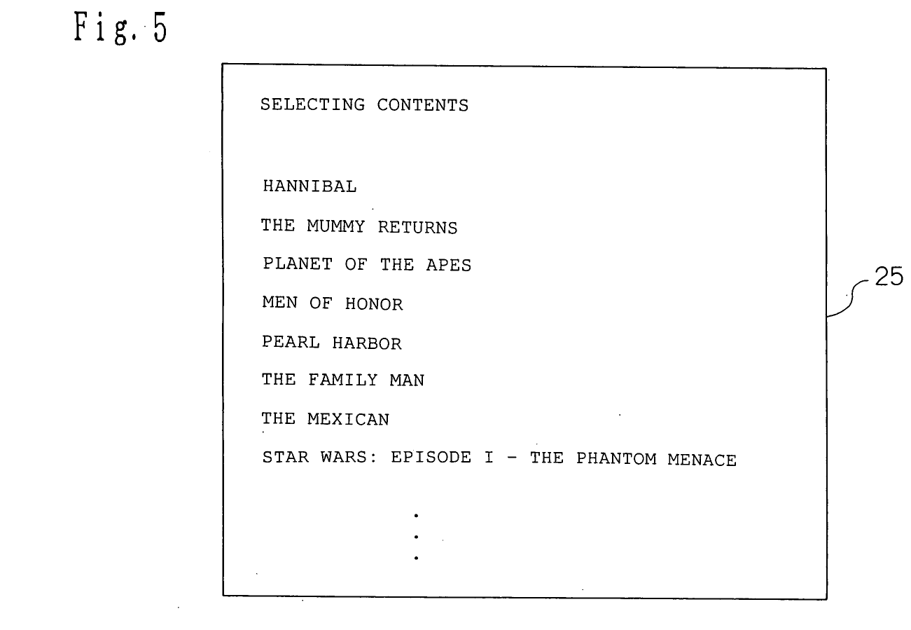

FIG. 5 shows a menu screen 25 displayed on the display means 12. The menu screen displays, for example, a list of movies produced as multi-angle software. Assume that the user selects the title of a movie, for example, ‘Hannibal’ on the menu screen 25 using the instruction means 10.

Then, as shown in an explanation screen request 43 shown in FIG. 8, the instruction means 10 transmits a request for the explanation screen of ‘Hannibal’ to the digest video providing means 6. Upon receipt of the explanation screen request 43, the digest video providing means 6 transmits the explanation screen to the receiving means 11 of the information terminal 9 as shown in the explanation screen transmission 44 shown in FIG. 8. The explanation screen received by the receiving means 11 is displayed on the display means 12.

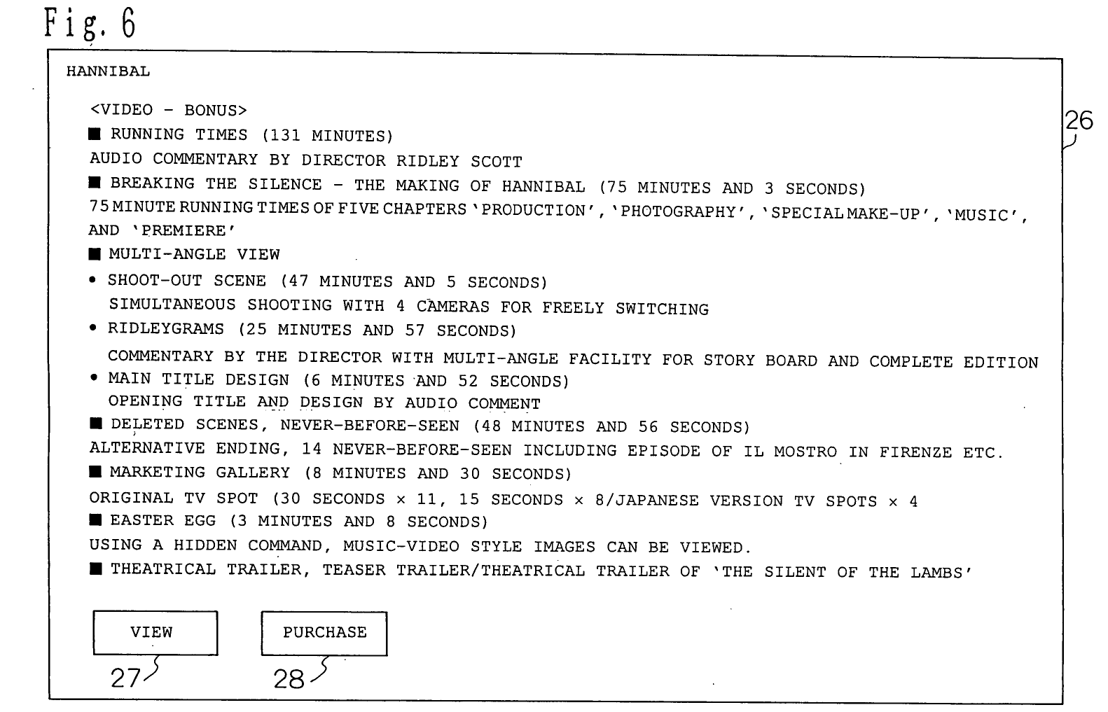

FIG. 6 shows an example of an explanation screen 26 displayed on the display means 12. The screen explains the contents of the movie ‘Hannibal’ which is multi-angle software. In the software, the scene of shoot-out (47 minutes and 5 seconds) is multi-angle video. By selecting and specifying view 27 and purchase 28, the user can view the digest video and purchase the complete edition of ‘Hannibal’.

Assume that the user of the information terminal 9 is considering purchasing the complete edition of ‘Hannibal’, and is considering whether or not it is to be purchased. In this case, the user operates the instruction means 10 and selects and specifies the view 27 on the explanation screen 26.

Then, the instruction means 10 transmits a request for the digest video to the digest video providing means 6 as indicated by digest video request 45 shown in FIG. 8. Upon receipt of the digest video request 45 (S2), the digest video providing means 6 transmits the digest video as indicated by digest video transmission 46 shown in FIG. 8 (S3). The digest video transmitted from the digest video providing means 6 is received by the receiving means 11, and displayed on the display means 12. In the digest video displayed on the display means 12, the portion specified by the playback starting time and the playback stop time in the multi-angle video as shown in FIG. 3 is played pack on the display means 12. Then, by selecting and specifying the leading still image of the digest video by the instruction means 10, the angle of the multi-angle video can be freely switched. The user of the information terminal 9 can interactively switch digest video and enjoy the digest video.

Thus, after the user of the information terminal 9 interactively operates and enjoys the digest video, and then operates the instruction means 10, the explanation screen 26 shown in FIG. 6 is displayed on the display means 12.

Assume that the user of the information terminal 9 enjoyed the digest video very much, and intends to purchase the complete edition of ‘Hannibal’, and selects and specifies the purchase 28 on the explanation screen 26 shown in FIG. 6. Then, a request for purchase information as shown in a purchase information request 47 shown in FIG. 8 is transmitted to the digest video providing means 6 from the instruction means 10.

Upon receipt of the purchase information request 47 (S4) the digest video providing means 6 transmits the purchase information as indicated by a purchase information transmission 48 shown in FIG. 8 to the information terminal 9. Upon receipt of the purchase information, the receiving means 11 displays the purchase information on the display means 12.

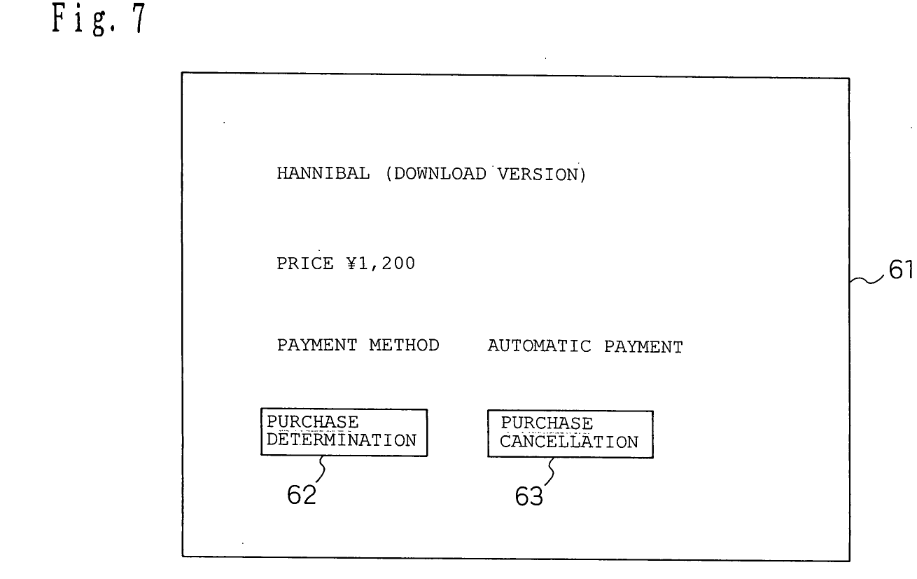

FIG. 7 shows a purchase information screen 61 which is the purchase information displayed on the display means 12. The price of ‘Hannibal’ and the payment method of the purchase price are displayed as the purchase information on the purchase information screen 61. The purchase can be determined by selecting and specifying a purchase determination 62, and the purchase can be canceled by selecting a purchase cancellation 63.

When the user purchases ‘Hannibal’, he or she operates the instruction means 10 and selects and specifies the purchase determination 62. Then, the instruction means 10 transmits an instruction to purchase ‘Hannibal’ as shown in a purchase instruction 49 shown in FIG. 8. The purchase instruction 49 is received by the accounting means 7 from the information terminal 9 through the network upline 22.

Upon receipt of the purchase instruction 49, the accounting means 7 performs an automatic payment process such as a payment by card, and transmits the purchase instruction 49 to the digest video providing means 6.

Thus, the digest video providing means 6 transmits ‘Hannibal’ to the information terminal 9 through the network downline 23 as indicated by a multi-angle software transmission 50 shown in FIG. 8 (S6).

Upon receipt of the multi-angle software, the receiving means 11 displays it on the display means 12. Thus, the user can view and enjoy ‘Hannibal’ displayed on the display means 12.

As described above, the video providing system according to the present embodiment transmits a menu screen and the explanation information from the video database 3 through the digest video providing means 6. When the user transmits a request for digest video through the instruction means 10 from the information terminal 9, the digest video providing means 6 refers to the address management table 8, and transmits the digest video at the corresponding address.

The user checks the digest video, and issues a purchase request to the accounting means 7 through the instruction means 10. In response to the request, the accounting means 7 requests the user to send account ID information such as a credit card number etc. through the terminal.

After the user inputs the corresponding information, the system refers to the address management table 8, retrieves the multi-angle software at the corresponding address in the video database 3, and transmits the information to the information terminal 9 through the digest video providing means 6. Thus, the user can interactively enjoy the digest video, and can determine whether or not he or she is to purchase the multi-angle software by referring to the received information.

In the present embodiment, the replication means 2 replicates the multi-angle software recorded on a DVD, but the embodiment is not limited to this application. That is, the replication means 2 can be replaced with compression means of MPEG compressing a video/audio signal so that an input video/audio signal can be MPEG compressed by the compression means and stored in the video database 3. Only a part of the multi-angle software stored in the video database 3 by the compression means includes multi-angle video as with the multi-angle software stored on the DVD according to the present embodiment, and the multi-angle video is used in the important scenes in the complete edition. When the above mentioned multi-angle software is stored in the video database 3, the effect of the present embodiment can be similarly obtained.

According to the present embodiment, all or a part of the multi-angle video is used as digest video. However, the embodiment is not limited to this application. That is, the video before the start of the multi-angle video can be defined as digest video. Additionally, the video after the end of the multi-angle video can also be defined as digest video. Furthermore, both the videos before and after the multi-angle video can be defined as digest video. Thus, by enhancing user expectation for interactive multi-angle software, the user's appetite for buying multi-angle software can be stimulated. In short, according to the present invention, digest video is to be specified from the AV data having multi-angle video using the above mentioned multi-angle video.

The video providing apparatus according to the present embodiment is an example of the first device of the present invention. The information terminal 9 according to the present embodiment is an example of the second device of the present invention. The video providing apparatus 1 according to the present embodiment is an example of the video specification apparatus of the present invention. The multi-angle software according to the present embodiment is an example of AV data of the complete edition according to the present invention. The multi-angle software according to the present embodiment is an example of AV data having the multi-angle video according to the present invention.

The program according to the present invention is a program used to direct a computer to perform all or a part of the steps (or processes, operations, effects, etc.) of the operations in the digest video specifying method according to the present invention, and operates in cooperation with the computer.

Furthermore, a medium according to the present invention stores a program used to direct a computer to perform all or a part of the steps of the operations in the digest video specifying method according to the present invention, and is computer-readable. The medium is used when the read program performs the operations in cooperation with the computer.

The program according to the present invention is a program used to direct a computer to perform all or a part of the steps (or processes, operations, effects, etc.) of the operations in the digest video providing method according to the present invention, and operates in cooperation with the computer.

Furthermore, the medium according to the present invention stores a program used to direct a computer to perform all or a part of the steps of the operations in the digest video providing method according to the present invention, and is computer-readable. The medium is used when the read program performs the operations in cooperation with the computer.

The abovementioned ‘a part of means (or a device, element, circuit, unit, etc.)’ according to the present invention, and the above mentioned ‘a part of steps (or a process, operation, effect, etc.)’ refer to some means or steps in the plurality of means or steps, or refer to a part of function or a part of operation in one means or step.

An embodiment of the program according to the present invention can be stored in a computer-readable storage medium, and can be operated in cooperation with a computer.

An embodiment of a program according to the present invention can be transmitted through a transmission medium, read by a computer, and operated in cooperation with the computer.

A data structure according to the present invention includes a database, a data format, a data table, a data list, a type of data, etc.

A storage medium includes ROM etc., and a transmission medium includes a transmission medium of Internet, light, electric wave, sound wave, etc.

Furthermore, the computer according to the present invention is not limited to pure hardware such as a CPU etc., but can be firmware, an OS, and a peripheral equipment.

As explained above, the configuration according to the present invention can be realized as software or hardware.

Described below will be the correlation among the inventions disclosed in the present specifications.

That is, the first invention is the digest video specification system comprising: a first device comprising retrieval means of retrieving multi-angle video from AV data having the multi-angle video, and digest video specification means of defining the multi-angle video as digest video; and a second device comprising receiving means of receiving the provided digest video.

The second invention is a digest video providing system, comprising: a first device comprising retrieval means of retrieving multi-angle video from AV data having the multi-angle video, digest video specification means of defining the retrieved multi-angle video as digest video, and providing means of providing the digest video; and a second device comprising receiving means of receiving the digest video.

The third invention is the digest video providing system according to the second invention in which the multi-angle video of the digest video can be interactively processed.

The fourth invention is the digest video providing system according to claim 2 in which the second device comprises request means of requesting the AV data of the complete edition by specifying the digest video, and the providing means of providing the AV data of the complete edition using the correspondence table between digest video and the AV data of the complete edition when a request is received from the request means.

The fifth invention is the digest video providing system according to the fourth invention in which the first device comprises accounting means of performing an accounting process before the providing means provides AV data of the complete edition.

The sixth invention is the digest video providing system according to any of the first through fifth inventions in which the AV data is stored on a DVD.

The seventh invention is a digest video specification apparatus comprising retrieval means of retrieving multi-angle video from AV data having the multi-angle video, and digest video specification means of defining the multi-angle video as digest video.

The eighth invention is a digest video providing apparatus comprising the digest video specification apparatus according to the seventh invention, and providing means of providing the digest video.

The ninth invention is the digest video providing apparatus according to the eighth invention in which the multi-angle video of the digest video can be interactively processed.

The tenth invention is the digest video providing apparatus according to the eighth invention in which the providing means provides AV data of the complete edition using the correspondence table between the digest video and the AV data of the complete edition when the AV data of the complete edition is requested by specifying the digest video.

The eleventh invention is a digest video providing apparatus according to the tenth invention comprising accounting means of performing an accounting process before transmitting the AV data of the complete edition.

The twelfth invention is the digest video specification apparatus according to the seventh invention in which the AV data is stored on a DVD.

The thirteenth invention is the digest video providing apparatus according to any of the eighth to eleventh inventions in which the AV data is stored on a DVD.

The fourteenth invention is a digest video receiving apparatus comprising receiving means of receiving digest video when the digest video of a digest video specification apparatus comprising retrieval means of retrieving multi-angle video from AV data having the multi-angle video, and digest video specification means of defining the multi-angle video as digest video is provided.

The fifteenth invention is a digest video receiving apparatus comprising receiving means of receiving digest video provided from a digest video providing apparatus comprising the digest video specification apparatus according to the fourteenth invention and providing means of providing the digest video.

The sixteenth invention is the digest video receiving apparatus according to the fifteenth invention in which multi-angle video of digest video can be interactively processed.

The seventeenth invention is the digest video receiving apparatus according to the fifteenth invention in which the providing means provides the AV data of the complete edition using the correspondence table between digest video and AV data of the complete edition when the receiving means specifies the digest video and requests the AV data of the complete edition.

The eighteenth invention is the digest video receiving apparatus according to the seventeenth invention in which the digest video providing apparatus comprises accounting means of performing an accounting process before transmitting the AV data of the complete edition.

The nineteenth invention is the digest video receiving apparatus according to the fourteenth invention in which the AV data is stored on a DVD.

The twentieth invention is the digest video receiving apparatus according to any of the fifteenth to eighteenth inventions in which the AV data is stored on a DVD.

The twenty-first invention is a digest video specifying method of specifying digest video from the AV data having multi-angle video using the multi-angle video.

The twenty-second invention is a digest video specifying method of retrieving the multi-angle video from the AV data having multi-angle video, and defining the multi-angle video as digest video.

The twenty-third invention is a digest video providing method using the digest video specifying method according to the twenty-second invention in which the multi-angle video is retrieved and provided.

The twenty-fourth invention is the digest video providing method according to the twenty-third invention in which multi-angle video of the digest video can be interactively processed.

The twenty-fifth invention is the digest video providing method according to the twenty-third invention in which the AV data of the complete edition is provided using the correspondence table between digest video and the AV data of the complete edition when the AV data of the complete edition is requested by specifying the digest video.

The twenty-sixth invention is the digest video providing method according to the twenty-fifth invention in which an accounting process is performed before the AV data of the complete edition is transmitted.

The twenty-seventh invention is the digest video specifying method according to the twenty-first or twenty-second invention in which the AV data is stored on a DVD.

The twenty-eighth invention is the digest video providing method according to the twenty-third to twenty-sixth inventions in which the AV data is stored on a DVD.

The twenty-ninth invention is a program used to direct a computer to perform all or a part of: a step of retrieving the multi-angle video from the AV data having multi-angle video; and a step of defining the multi-angle video as digest video in the digest video specifying method according to the twenty-second invention.

The thirtieth invention is a program used to direct a computer to perform all or a part of: a step of retrieving the multi-angle video from the AV data having multi-angle video; a step of defining the multi-angle video as digest video; and a step of retrieving and providing the multi-angle video in the digest video providing method according to the twenty-third invention.

The thirty-first invention is the medium storing the program according to the twenty-ninth invention in which the medium can be processed by a computer.

The thirty-second invention is the medium storing the program according to the thirtieth invention in which the medium can be processed by a computer.

### Industrial Applicability

As apparent from the above description, the present invention can provide a digest video specification system, a digest video providing system, a digest video specification apparatus, a digest video providing apparatus, a digest video specifying method, a digest video providing method, a medium and a program for the systems, apparatuses, and methods of providing digest video so that necessary operations are not complicated, and can be performed at a low cost in producing digest video from AV data.

Furthermore, the present invention can provide a digest video specification system, a digest video providing system, a digest video specification apparatus, a digest video providing apparatus, a digest video specifying method, a digest video providing method, a medium and a program for the systems, apparatuses, and methods of providing digest video so that the interesting elements of software can be interactively presented.

1-16. (canceled)

17. A digest video providing system, comprising:
a digest video providing apparatus of preparing and providing a digest video;
an information terminal of receiving said digest video provided from said digest video providing apparatus and displaying said received digest video, wherein
said digest video providing apparatus has:
retrieval means of retrieving multi-angle video from AV data which is time-sequential and in which the multi-angle video is partially inserted in video which is not the multi-angle video;
digest video specification means of extracting digest video which is multi-angle video from said multi-angle video retrieved by said retrieval means; and
providing means of providing said digest video extracted by the digest video specification means, and
said information terminal has displaying means of receiving and displaying said digest video provided by said providing means.

18. The digest video providing system according to claim 17, wherein said multi-angle video comprises a plurality of videos which are recorded by a plurality of cameras and which proceed concurrently at the same time period and one of which can be selected freely by user.

19. The digest video providing system according to claim 17 or 18, wherein said digest video providing apparatus has an address management table of making correspondence of digest video to AV data of a complete edition, and said providing means provides said AV data of the complete edition using said address management table when said AV data of the complete edition is requested by specifying said digest video.

20. The digest video providing system according to claim 17 or 18, wherein said digest video specification means extracts said digest video from said multi-angle video in just the state said multi-angle video is, and said displaying means can switch and display said multi-angle video.

21. The digest video providing system according to claim 20, wherein said digest video providing apparatus has address management table of including branch target information of multi-angle video, and said displaying means can switch and display said multi-angle video using said branch target information.

22. The digest video providing system according to claim 19, further comprising accounting means of performing an accounting process before transmitting said AV data of said complete edition.

23. The digest video specification system according to claim 17, wherein said AV data is stored on a DVD.

24. A digest video providing apparatus of preparing and providing a digest video, comprising;
retrieval means of retrieving multi-angle video from AV data which is time-sequential and in which the multi-angle video is partially inserted in video which is not the multi-angle video;
digest video specification means of extracting digest video from said multi-angle video retrieved by said retrieval means; and
providing means of providing said digest video extracted by the digest video specification means.

25. The digest video providing apparatus according to claim 24, wherein said multi-angle video is composed of a plurality of video which are recorded by a plurality of cameras and which proceed concurrently at the same time period and one of which can be selected freely by user.

26. The digest video providing apparatus according to claim 24 or 25, wherein said digest video specification means extracts said digest video from said multi-angle video in just the state said multi-angle video is.

27. A digest video providing method using a digest video specifying system, including;
a digest video providing apparatus of preparing and providing a digest video;
an information terminal of receiving said digest video provided from said digest video providing apparatus and displaying said received digest video,
a retrieval step of retrieving multi-angle video from AV data which is time-sequential and in which the multi-angle video is partially inserted in video which is not the multi-angle video;
a digest video specification step of extracting digest video from said multi-angle video retrieved by said retrieval step; and
a providing step of providing said digest video extracted by the digest video specification step, and
a displaying step of receiving and displaying on said information terminal said digest video provided by said providing step.

28. A program which is used in a digest video specifying system according to claim 17, and is used to direct a computer to function:
retrieval means of retrieving multi-angle video from AV data which is time-sequential and in which the multi-angle video is partially inserted in video which is not the multi-angle video;
digest video specification means of extracting digest video from said multi-angle video retrieved by said retrieval means;
providing means of providing said digest video extracted by the digest video specification means; and
displaying means of receiving and displaying said digest video provided by said providing means.
